(19) United States
(12) Patent Application Publication
(10) Pub. No.: US 2021/0192389 A1
(43) Pub. Date: Jun. 24, 2021

(54) METHOD FOR AI OPTIMIZATION DATA GOVERNANCE

(71) Applicant: Beijing Zhongchuang Telecom Test Co., Ltd., Beijing (CN)

(72) Inventors: Songyuan Guan, Beijing (CN); Xicen Tang, Beijing (CN); Jingbao Tang, Beijing (CN)

(21) Appl. No.: 16/729,806

(22) Filed: Dec. 30, 2019

(30) Foreign Application Priority Data
Dec. 23, 2019 (CN) 201911337039.1

(51) Int. Cl. G06N 20/00; G06N 5/04

(52) U.S. Cl. CPC G06N 20/00; G06N 5/04

(57) ABSTRACT

The present invention discloses a method for optimization data governance, including AI data collection and processing, AI optimization metadata and intelligent data quality assessment management. AI data collection and processing includes data access, data conversion, data loading and policy template saving as well as data quality assessment management. AI optimization metadata includes technical metadata and business metadata. Intelligent data quality assessment management adopts AI definition transformation rules to extract data quality assessment dimensions. By introducing AI technology into data governance, this application proposal realizes the improvement in data quality and the improvement in mining the association and blood relationship among data, provides a unified policy template library, and then enriches the policy templates of data governance in various industries through AI learning.

### TECHNICAL FIELD

The present invention relates to AI optimization data governance technology, belonging to the field of data governance, in particular to an AI optimization data governance method.

### BACKGROUND

Because of historical construction, many data systems used now are all the stovepipe-type construction in a certain field, most of which belong to data island and cannot be interconnected. Therefore, it is difficult to mine data association and analyze data blood relationship among systems, greatly reducing the value of data, and thus giving birth to data governance system. Data governance is to extract all kinds of data in a unified way, find the relationship among data through various customized technologies, and form a unified data resource pool for external services. The overall goal of data governance is to improve data quality, ensure data security, and realize the sharing and integration of data resources in various organizations and departments. In the data governance, after the routine data extraction, conversion, cleaning, de-duplication, supplementing, association, fusion, comparison, identification and other operations for various data sources, a unified original database, resource database, subject database, special database and other database are generated, and a unified data resource directory is provided externally.

At present, most of data governance uses standard ETL, and only merges through keywords and business rules, without semantic fusion and intelligent policy configuration template, so the current intelligence in data governance is not high, resulting in insufficient data association. According to different industry application scenarios, the existing data governance technology mostly uses the key in technical metadata (such as database table definition) for ETL, unable to carry out synonym conversion comparison and semantic correlation analysis of data. The existing technical solutions generally have the characteristics of customized development and complex implementation, and have high requirements for technical developers and business personnel.

The application proposes a method for intelligent data governance combined with AI, and meantime combined with the pre-prepared policy template and automatically updated policy template after AI learning. After the data is processed by ETL, when the data quality is not satisfied, it is not discarded directly. Instead, an intelligent loop feedback is used to reprocess the data by ETL. Moreover, according to the training results of a large number of data after the system is put into operation, the optimized ETL strategy suitable for the industry is built-in and saved to avoid customized development for each industry. Meanwhile, it can adjust the maximum number of loops to balance the efficiency and accuracy. The scheme has been applied in many practical projects and achieved good results.

Therefore, a method for AI optimization data governance is proposed.

### SUMMARY

The purpose of the present invention is to provide a method for AI optimization data governance. By introducing AI technology into data governance, the application proposal realizes the improvement in data quality and the improvement in mining the association and blood relationship among data, provides a unified policy template library, and then enriches the policy templates of data governance in various industries through AI learning.

Furthermore, the application proposal innovatively introduces classification learning, function learning, regression and other technologies to adjust dynamically transformation rules and the weight of each dimension of the data quality assessment standard, to avoid too much interference from human experience.

To achieve the above purpose, the present invention provides the following technical scheme including AI data collection and processing, AI optimization metadata and intelligent data quality assessment management.

AI data collection and processing includes data access, data conversion, data loading, policy template saving and data quality assessment management.

AI optimization metadata includes technical metadata and business metadata.

Intelligent data quality assessment management adopts AI definition transformation rules to extract data quality assessment dimensions.

Preferably, the technical metadata includes database table structures, transformation rules and data histories.

Preferably, business metadata includes business meanings, data standards, indicator meanings and measurement methods.

Preferably, the indicators of intelligent data quality assessment management include integrity, standardization, consistency, accuracy, uniqueness and timeliness.

Preferably, the AI definition transformation rules adopt the classification learning, function learning and regression technology in machine learning. By extracting effective data quality assessment indicators, and according to the mapping and integration of technical metadata and business metadata, the weight coefficients of intelligent data quality assessment management indicators are dynamically adjusted, so as to improve transformation rules and data quality assessment dimensions. In addition, as data volumes and business expectations change, the data quality improvement scheme is updated dynamically.

Compared with the existing technology, the present invention has the following beneficial effect: By introducing AI technology into data governance, the application proposal realizes the improvement in data quality and the improvement in mining the association and blood relationship among data, provides a unified policy template library, and then enriches the policy templates of data governance in various industries through AI learning.

Furthermore, the application proposal innovatively introduces classification learning, function learning, regression and other technologies to adjust dynamically transformation rules and the weight of each dimension of the data quality assessment standard, so as to avoid too much interference from human experience.

### BRIEF DESCRIPTION OF THE DRAWINGS

FIG. 1 is the flow of the AI optimization data governance method of the present invention;

FIG. 2 is the flow of AI optimization metadata of the present invention.

### DETAILED DESCRIPTION

The technical scheme in the embodiments of the present invention will be described clearly and completely in the following summary combined with figures in the embodiment of the invention. Obviously, the described embodiments are only some of the embodiments of the present invention. Based on the embodiments in the present invention, all other embodiments obtained by common technicians in the field without creative labor belong to the scope of protection required by the present invention.

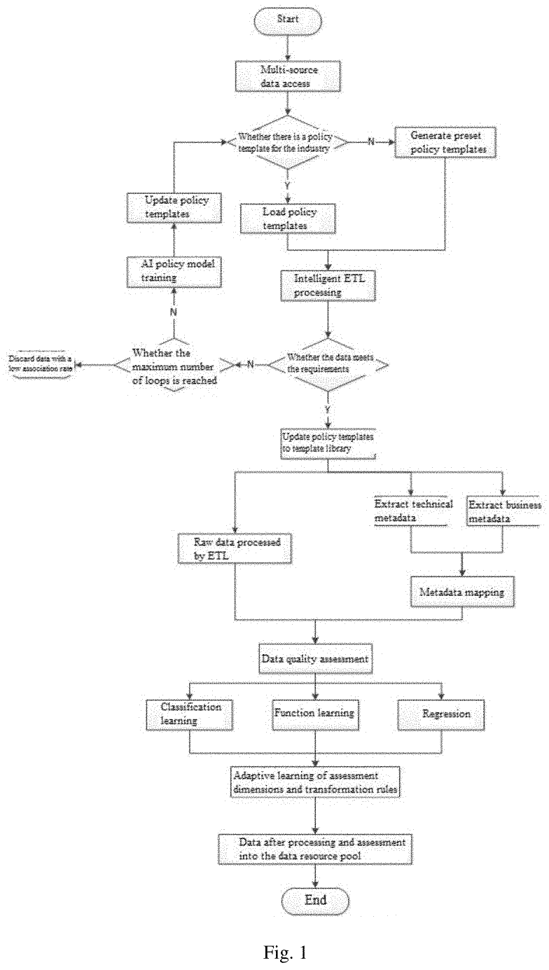

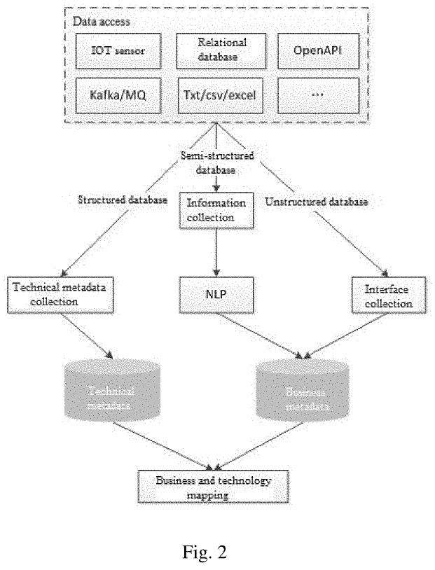

As shown in FIGS. 1 to 2, the present invention provides a technical scheme as follows:

AI data collection and processing, AI optimization metadata and intelligent data quality assessment management are included. AI data collection and processing includes data access, data conversion, data loading, policy template saving and data quality assessment management. AI optimization metadata includes technical metadata and business metadata. Intelligent data quality assessment management adopts AI definition transformation rules to extract data quality assessment dimensions.
I. AI data collection and processing is as follows. The data extracted to be processed is processed by intelligent ETL, and strategy and machine learning are introduced for feedback loop.
Extraction: Generate a strategy by collected data and dependence of condition function, and filter and clear redundant data.
Conversion: The missing data is supplemented and completed through the strategy, the wrong data is corrected or deleted (i.e. denoising), and the data is finally sorted into the data that we can further process and use.
Loading (cleaning): Arrange the data on demand, meantime use the strategy training model fed back by users and combine with the AI deep learning technology to further update the strategy and make a loop feedback. Moreover, save the templates that meet the requirements by category, and finally input the data that meet the requirements into the subsequent data quality assessment module.
II. AI optimization metadata is as follows. Metadata is the data to describe data, that is, the information related to data characteristics. In the scheme, metadata is divided into technical metadata and business metadata according to its purpose. Technical metadata includes database table structures, transformation rules and data histories. Business metadata includes business meanings, data standards, indicator meanings, and measurement methods.
(1) AI Extraction of Key Information from Semi-Structured Data

In the scheme, NLP and other AI technologies are used to collect the metadata of semi-structured data, realize the construction of the initial business lexicon of metadata, and constantly improve the data quality according to the metabase configuration mapping rules.

### (2) AI Technology Maintains Metadata

In the scheme, AI technology such as similarity analysis is used to eliminate repeated and inconsistent metadata in metadata storage or data dictionary, and reliable query threshold is proposed by setting metadata quality rules to ensure the data quality of metadata.

### (3) AI Technology Realizes the Integration of Metadata

In the scheme, AI technology such as association analysis is used to map business metadata and technical metadata, realize the function of intelligently monitoring key nodes and optimizing nodes, and solve problems such as quality control and semantic filtering, thus improving the quality of metadata stored.

### III. Intelligent Data Quality Assessment Management

Data quality is the basis of data application, and the index system to measure data quality includes the following:

Integrity: Whether the data is missing; Standardization: Whether the data is stored according to the required rules; Consistency: Whether there is a conflict in the meaning of information for the value of data; Accuracy: Whether the data is correct; Uniqueness: Whether the data is repeated; Timeliness: Whether the data reflects the objective facts in time.

In the scheme, AI definition transformation rules is used to extract data quality evaluation dimensions. Specifically, by using the classification learning, function learning, regression and other technologies in machine learning, through extracting effective data quality assessment indicators (the six indicators above), according to the mapping and integration of technical metadata and business metadata, the weight coefficients of the six indicators are dynamically adjusted, so as to improve transformation rules and data quality assessment dimensions. In addition, as data volumes and business expectations change, the data quality improvement scheme is updated dynamically.

Although embodiments of the present invention have been shown and described, it can be understood that common technicians in the field can make various changes, modifications, substitutions and variants to these embodiments without departing from the principles and spirits of the present invention. The scope of the present invention is defined by the appended claims and their equivalents.

We claim:

1. A method for AI optimization data governance is characterized in AI data collection and processing, AI optimization metadata and intelligent data quality assessment management.
AI data collection and processing includes data access, data conversion, data loading, policy template saving and data quality assessment management.
AI optimization metadata includes technical metadata and business metadata.
Intelligent data quality assessment management adopts AI definition transformation rules to extract data quality assessment dimensions.

2. The method for AI optimization data governance described in claim 1, is characterized in that the technical metadata includes database table structures, transformation rules and data histories.

3. The method for AI optimization data governance described in claim 1, is characterized in that the business metadata includes business meanings, data standards, indicator meanings and measurement methods.

4. The method for AI optimization data governance described in claim 1, is characterized in that the indicators of intelligent data quality assessment management include integrity, standardization, consistency, accuracy, uniqueness and timeliness.

5. The method for AI optimization data governance described in claim 4, is characterized as follows. AI definition transformation rules adopt classification learning, function learning and regression technology in machine learning. By extracting effective data quality assessment indicators, and according to the mapping and integration of technical metadata and business metadata, the weight coefficients of intelligent data quality assessment management indicators are dynamically adjusted, so as to improve transformation rules and data quality assessment dimensions. In addition, as data volumes and business expectations change, the data quality improvement scheme is updated dynamically.
